(19) United States
(12) Patent Application Publication
(10) Pub. No.: US 2010/0237704 A1
(43) Pub. Date: Sep. 23, 2010

(54) SINGLE-PHASE TO N-PHASE CONVERTER AND POWER CONVERSION SYSTEM

(75) Inventors: Atsushi NAKAJIMA, Utsunomiya-shi (JP); Akio Tsumasaka, Utsunomiya-shi (JP); Fumihiko Shimazu, Tochigi-ken (JP); Mamoru Kokubu, Utsunomiya-shi (JP); Katsuhiko Konno, Utsunomiya-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/729,935

(22) Filed: Mar. 23, 2010

(30) Foreign Application Priority Data
Mar. 23, 2009 (JP) 2009-070109

(51) Int. Cl. H02P 13/00; H02M 5/02

(52) U.S. Cl. 307/83; 363/154

(57) ABSTRACT

A single-phase to n-phase converter and a power conversion system are capable of easily connecting n (n represents an integer of 3 or greater) single-phase electric generators to an n-phase electric power system. The single-phase to n-phase converter includes n (n represents an integer of 3 or greater) single-phase electric generators, and a single-phase to n-phase transformer for converting n single-phase electric power outputs from the n single-phase electric generators into an n-phase system output, and then supplying the n-phase system output to a primary side of the single-phase to n-phase transformer. The n single-phase electric generators are connected to a secondary side of the single-phase to n-phase transformer.

### CROSS-REFERENCE TO RELATED APPLICATION

This application is based upon and claims the benefit of priority from Japanese Patent Application No. 2009-070109 filed on Mar. 23, 2009, of which the contents are incorporated herein by reference.

### BACKGROUND OF THE INVENTION

1. Field of the Invention

The present invention relates to a single-phase to re-phase converter and a power conversion system for linking or connecting n (n represents an integer of 3 or greater) single-phase electric generators to an n-phase electric power system.

2. Description of the Related Art

It would be convenient if the n electric power outputs from single-phase electric generators, each in the form of a combination of a solar cell module and an inverter for use with residential houses, could be converted into electric power suitable for use in an n-phase electric power system for public or industrial use, such as a three-phase AC power supply, for example.

Heretofore, a Scott-T transformer, for example, has been used to derive two single-phase AC power supplies from a three-phase AC power supply. Such a Scott-T transformer may be used to convert two single-phase AC power supplies into a three-phase AC power supply. However, currents of the three-phase AC power supply cannot be brought into equilibrium if the two single-phase loads (single-phase electric generators) are identical to each other.

There also has been known in the art a Steinmetz circuit, which operates as a circuit for converting a three-phase AC power supply into single-phase AC power supplies. Such a Steinmetz circuit lacks a voltage regulating function, and hence does not lend itself to being used as a system linkage that operates as a circuit for converting single-phase AC power supplies into a three-phase AC power supply.

Japanese Laid-Open Patent Publication No. 2003-219646 discloses a three-phase to single-phase conversion circuit, wherein the resistor of a Steinmetz circuit is replaced with the primary winding of a transformer, and a single-phase load is connected across the secondary winding of the transformer. When the disclosed three-phase to single-phase conversion circuit is used as a single-phase to three-phase conversion circuit, the capacitor and the inductor must be adjusted depending on the capacitance of the single-phase electric generator. Therefore, the disclosed three-phase to single-phase conversion circuit is not suitable for use with electric generators, the generated power of which varies from time to time. For example, such a three-phase to single-phase conversion circuit cannot be used with electric generators that rely on natural energy, such as solar energy.

### SUMMARY OF THE INVENTION

It is an object of the present invention to provide a single-phase to n-phase converter and a power conversion system, which are capable of easily connecting n (n represents an integer of 3 or greater) single phase electric generators to an n-phase electric power system.

A single-phase to n-phase converter according to the present invention includes n (n represents an integer of 3 or greater) single-phase electric generators, and a single-phase to n-phase transformer for converting n single-phase electric power outputs from the n single-phase electric generators into an n-phase system output and supplying the n-phase system output to a primary side of the single-phase to n-phase transformer, the n single-phase electric generators being connected to a secondary side of the single-phase to n-phase transformer.

Since the single-phase to n-phase converter includes the single-phase to n-phase transformer, which converts n single-phase electric power outputs from the n single-phase electric generators into an n-phase system output, and then supplies the n-phase system output to the primary side of the single-phase to n-phase transformer, it is easy to connect the n single phase electric generators to an n-phase electric power system.

The single-phase to n-phase transformer may comprise a single transformer having separate cores for each of respective n phases, or n transformers for each of respective n phases. If the single-phase to n-phase converter further includes a capacitive phase advancer connected to the primary side of the single-phase to n-phase transformer, then a lagging power factor due to the single-phase to n-phase transformer can be improved.

If the single-phase to n-phase converter further includes a standby power cutting-off device connected to the primary side of the single-phase to n-phase transformer, then losses, which are caused by the transformer when no electric power is consumed by an n-phase system connected to the transformer, can be eliminated.

If the standby power cutting-off device is connected to an output side of the capacitive phase advancer, then a lagging power factor due to the single-phase to n-phase transformer can be improved, and losses caused by the transformer can be eliminated.

If the single-phase to n-phase transformer has primary windings on the primary side thereof, which have respective voltage regulating taps, then desired voltages can be obtained from the n-phase system output.

The number n may be 3, thereby providing a single-phase to three-phase converter having a relatively simple structure.

The single-phase electric generators may comprise respective solar cells and respective inverters, which are supplied with DC outputs from the solar cells. Accordingly, single-phase electric generators suitable for home use can easily be connected to a high-output n-phase electric power system intended for public use.

A power conversion system according to the present invention includes the single-phase to n-phase converter described above, an n-phase system power supply, and an n-phase load for being supplied with electric power from the single-phase to n-phase converter and the n-phase system power supply.

According to the present invention, the n single-phase electric generators can easily be connected to an n-phase electric power system.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a power conversion system, which incorporates therein a single-phase to three-phase converter according to an embodiment of the present invention;

FIG. 2 is a circuit diagram, partially in block form, of the power conversion system shown in FIG. 1;

FIG. 3 is a circuit diagram of three transformers having separate cores for each of respective three phases;

FIG. 4 is a circuit diagram of a single transformer having a common core shared by three phases;

FIG. 5 is a circuit diagram of a transformer having voltage regulating taps on a three-phase three wire primary side thereof;

FIG. 6 is a block diagram of a power conversion system, showing a capacitive phase advancer;

FIG. 7A is a diagram illustrating a lagging power factor; and

FIG. 7B is a diagram illustrating the power factor improved by the capacitive phase advancer.

### DESCRIPTION OF THE PREFERRED EMBODIMENTS

A single-phase to n-phase (n represents an integer of 3 or greater) converter according to an embodiment of the present invention will be described below with reference to the drawings. For illustrative purposes, “n-phase” will be described as “three-phase” below.

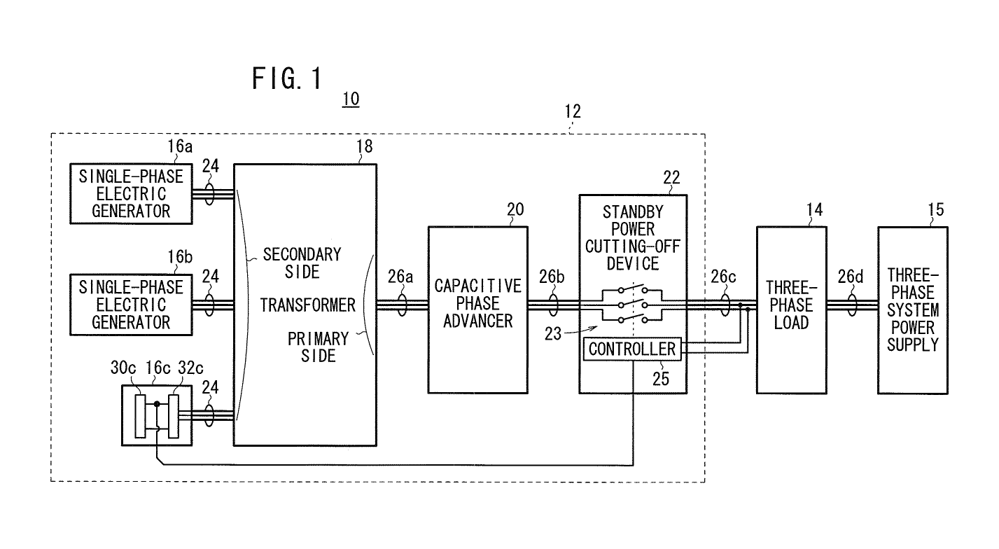

FIG. 1 shows in block form a power conversion system 10, which incorporates therein a single-phase to three-phase converter 12 according to an embodiment of the present invention. As shown in FIG. 1, the single-phase to three-phase converter 12 comprises three single-phase electric generators 16a, 16b, 16c each of which outputs a single-phase three-wire 200 V system output, a single-phase to three-phase transformer 18 for converting the single-phase three-wire 200 V system outputs from the single-phase electric generators 16a, 16b, 16c into a three-phase three-wire 200 V system output, a capacitive phase advancer 20, and a standby power cutting-off device 22. The capacitive phase advancer 20 and the standby power cutting-off device 22 may be added only when required, in view of the cost of the power conversion system 10 and the quality of the power supply combined therewith.

The power conversion system 10 includes the single-phase to three-phase converter 12, and a three-phase load (n-phase load) 14, which is supplied with electric power from the single-phase to three-phase converter 12 and/or from a three-phase system power supply (n-phase system power supply) 15 for industrial or public use, which generates a three-phase three-wire 200 V system output.

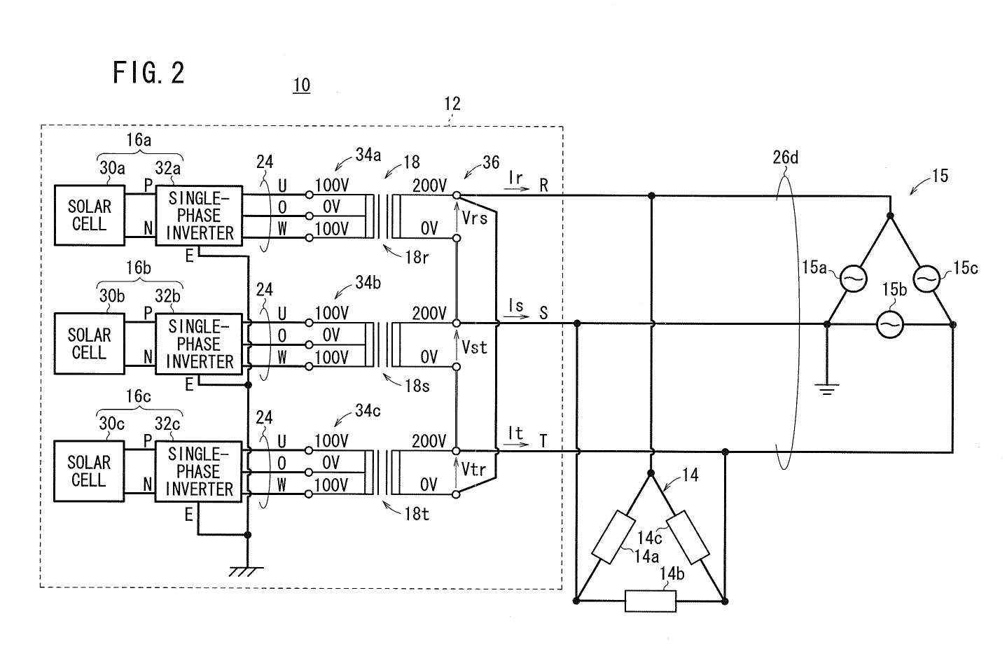

FIG. 2 is a circuit diagram showing the power conversion system 10 by way of example. In FIG. 2, the capacitive phase advancer 20 and the standby power cutting-off device 22, both of which will be described in detail later, have been omitted from illustration.

As shown in FIG. 2, the single-phase electric generators 16a, 16b, 16c comprise respective solar cells 30a, 30b and 30c, and respective single-phase inverters 32a, 32b and 32c. The solar cells 30a, 30b, 30c generate DC electric power outputs between positive terminals P and negative terminals N thereof, which are converted by the single-phase inverters 32a, 32b, 32c into single-phase three-wire 200 V system outputs 34a, 34b and 34c, respectively. The single-phase three-wire 200 V system outputs 34a, 34b, 34c are then supplied respectively through three sets of wires 24 (U-O-W) to the respective secondary windings of transformers 18r, 18s, 18t of the single-phase to three-phase transformer 18.

The single-phase three-wire 200 V system outputs 34a, 34b, 34c are converted by the transformers 18r, 18s, 18t into a three-phase three-wire 200 V system output 36, which exists across the primary windings of the transformers 18r, 18s, 18t.

The single-phase three-wire 200 V system outputs 34a, 34b, 34c produce AC voltages of 100 V on the output sides of the single-phase inverters 32a, 32b, 32c, between phases U and O and phases W and O.

The three-phase three-wire 200 V system output 36 produces AC voltages (phase voltages) Vrs, Vrt, Vtr of 200 V across the primary windings of the transformers 18r, 18s, 18t. The primary windings of the transformers 18r, 18s, 18t correspond to phases R, S, T of the three-phase three-wire 200 V system output 36. The phase S is grounded with respect to the three-phase system power supply 15. The single-phase inverters 32a, 32b, 32c have respective ground terminals E, which are not grounded with respect to the three-phase system power supply 15. The secondary windings of the transformers 18r, 18s, 18t have center taps O (0 V), which may be floating center taps. The center taps O of the secondary windings of the transformers 18r, 18s, 18t are grounded.

The phases R, S, T of the three-phase three-wire 200 V system output 36, i.e., the phase voltages Vrs, Vrt, Vtr that are generated across the primary windings of the transformers 18r, 18s, 18t, are applied respectively to loads 14a, 14b, 14c of the three-phase load 14. The primary windings of the transformers 18r, 18s, 18t are delta-connected. Alternatively, the primary windings of the transformers 18r, 18s, 18t may be wye-connected. Similarly, the loads 14a, 14b, 14c are delta-connected, although they may be wye-connected. Line currents Ir, Is, It flow respectively in the phases R, S, T.

The loads 14a, 14b, 14c also are supplied with electric power via three wires from respective phase system power supplies 15a, 15b, 15c of the three-phase system power supply 15.

Therefore, the loads 14a, 14b, 14b are supplied with electric power from the system of the single-phase to three-phase converter 12, as well as with electric power from the system of the three-phase system power supply 15, thereby providing a interconnecting system between the single-phase to three-phase converter 12 and the three-phase system power supply 15.

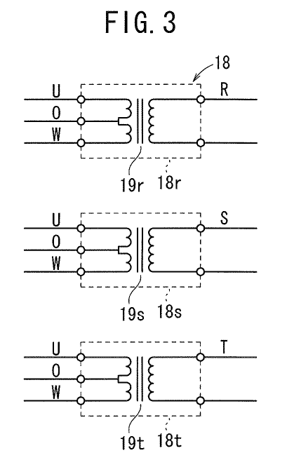

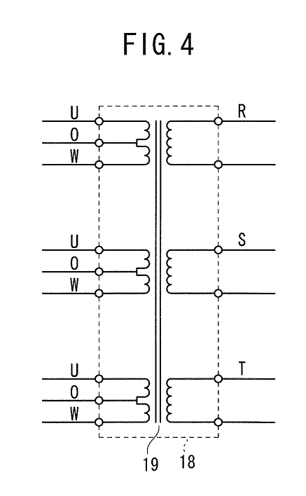

As shown in FIG. 3, the transformer 18 may comprise three transformers 18r, 18s, 18t having respective cores 19r, 19s, 19t for the respective phases R, S, T. Alternatively, as shown in FIG. 4, the transformer 18 may comprise a single transformer 18 having three cores 19, which are provided separately for the respective phases R, S, T.

The transformer 18 serves three purposes. The first purpose is to provide three single-phase three-wire 200 V system outputs 34a, 34b, 34c, as seen from the output sides of the single-phase inverters 32a, 32b, 32c of the single-phase electric generators 16a, 16b, 16c. The second purpose is to isolate the primary side, i.e., the three-phase system power supply 15, and the secondary side, i.e., the single-phase three-wire 200 V system outputs 34a, 34b, 34c, from each other, so as to eliminate any potential disagreement therebetween. Generally, as shown in FIG. 2, the phase S of the three-phase three-wire 200 V system output 36 is grounded. The third purpose, which is related to the first purpose, is to generate the voltages 100 V−0 V−100 V of the single-phase three-wire 200 V system outputs 34a, 34b, 34c.

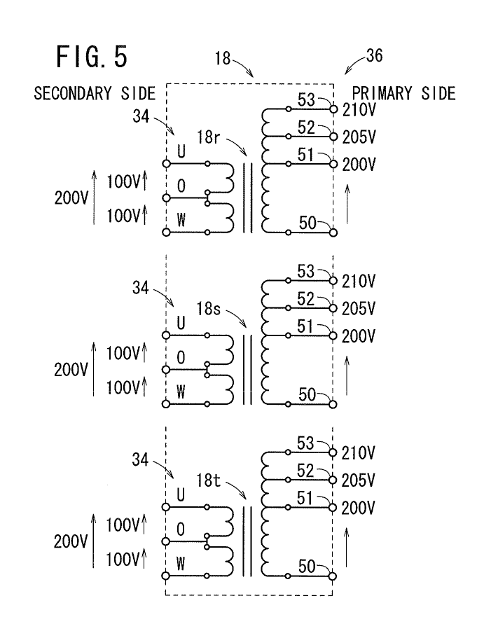

As shown in FIG. 5, each of the primary windings of the transformers 18r, 18s, 18t should preferably have voltage regulating taps 51, 52, 53 that provide voltages of 200 V, 205 V and 210 V, respectively.

More specifically, when the single-phase electric generators 16a, 16b, 16c on the secondary side (hereinafter also referred to as the “single-phase electric generator side”) are made to supply electric power through the transformer 18 to the three-phase three-wire 200 V system output 36 on the primary side (hereinafter also referred to as the “system side”), it is necessary for the voltage on the single-phase electric generator side to be higher than the voltage on the system side, since the impedance of the transformer 18 is higher. If the voltages of the single-phase electric generators 16a, 16b, 16c are too high, then a system side voltage increase protecting function of the single-phase electric generators 16a, 16b, 16c is activated in order to limit the input thereof, thereby tending to lower the actual power output of the power conversion system 10, compared with the rated power output thereof.

Generally, the voltage of each of the phases of the phase system power supplies 15a, 15b, 15c of the three-phase system power supply 15 often is higher than 200 V, e.g., about 210 V. Therefore, each of the primary windings of the transformers 18r, 18s, 18t includes, in addition to the tap 51 for the voltage of 200 V, other voltage regulating taps 52, 53 for providing respective voltages of 205 V and 210 V in order to meet the voltage requirements on the system side, which is linked with the single-phase electric generators 16a, 16b, 16c.

Typical transformers are designed such that the voltage on the secondary side thereof is slightly higher than the voltage on the primary side, taking into consideration a voltage drop, which is caused by the load connected to the transformer. Since energy flows from the secondary side to the primary side in the transformer 18 of the single-phase to three-phase converter 12, the transformer 18 is designed to have a winding ratio, which provides 200 V on the primary side and about 198 V on the secondary side, in view of the voltage increase in the single-phase electric generators 16a, 16b, 16c on the secondary side.

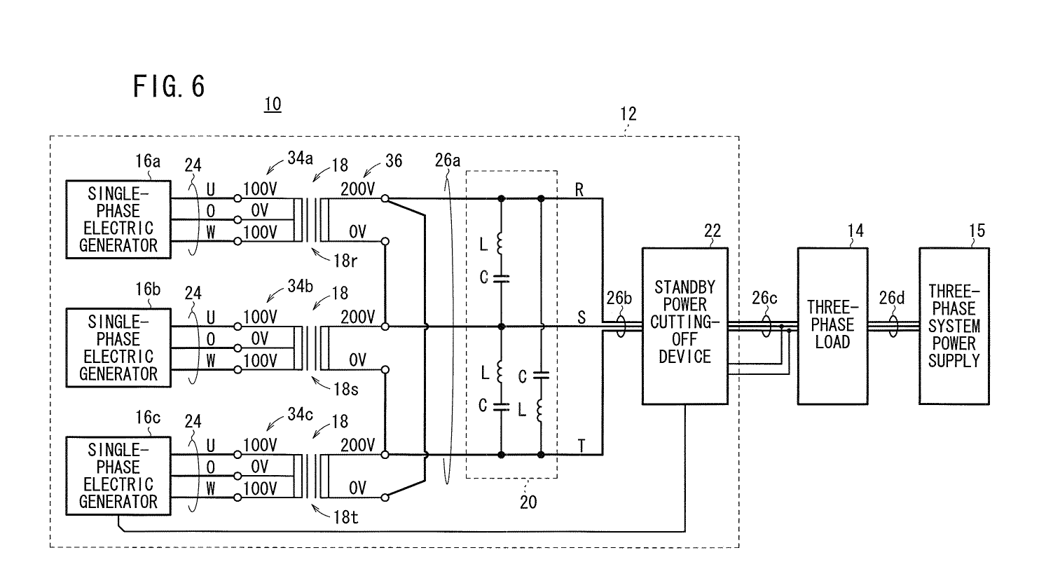

The capacitive phase advancer 20 will be described below with reference to FIG. 6. The single-phase inverters 32a, 32b, 32c of the single-phase electric generators 16a, 16b, 16c are controlled to provide a power factor of 1, such that the interphase voltages and phase currents of the wires 24 (U-O-W) on the secondary side of the transformer 18 are in phase. However, since the transformer 18 is inductive, the primary side of the transformer 18, which produces the three-phase three-wire 200 V system output 36, has a lagging power factor, i.e., a lower power factor.

In order to prevent the power factor from being lowered, as shown in FIG. 6, the capacitive phase advancer 20 is inserted between three lines 26b (see FIG. 1), which are connected to the input side of the standby power cutting-off device 22, and three lines 26a (see FIG. 1), which are connected to the primary side of the transformer 18. The capacitive phase advancer 20 comprises three series-connected circuits, each made up of an inductor L for preventing an inrush current, and a phase advancing capacitor C, which is connected between the phases R and S, the phases S and T, and the phases R and T.

With respect to the power factor, the article, “Guidelines for Technical Requirements for Grid Interconnections for Power Quality Assurance” (Oct. 1, 2004) has been published by the Agency for Natural Resources and Energy. According to these Guidelines, it is necessary for the single-phase to three-phase converter 12 to have a leading power factor of 0.95 or greater, as seen from the single-phase electric generators 16a, 16b, 16c.

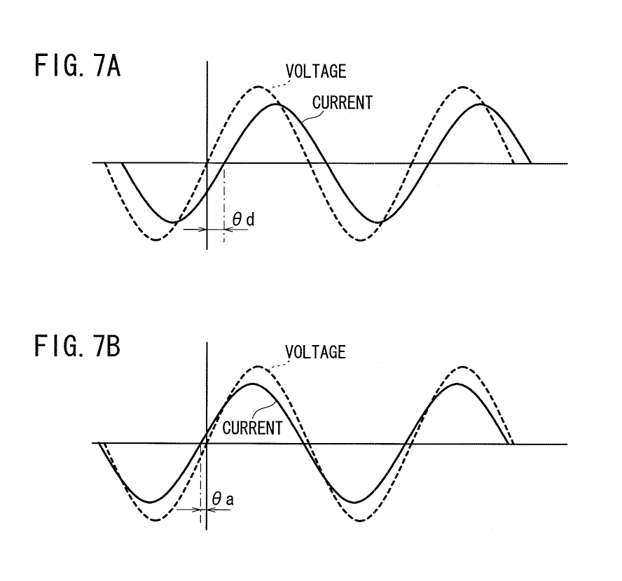

Actually, as shown in FIG. 7A, the transformer 18 causes the current to lag in phase behind the voltage, by θd. However, as described above, since the capacitive phase advancer 20 is inserted, the power factor is improved to a range of from 1 to 0.95 in order to reduce the voltage-current phase difference from θd to θa. According to the above Guidelines, a voltage-current phase difference is permitted up to ±18° {18°=COS⁻¹(0.95)}.

For example, if the impedance of the inductor L is set at 6% of the impedance of the phase advancing capacitor C at a frequency of 50 Hz, then assuming a lagging power factor of 0.7, a phase difference of 45°, a phase voltage of 200 [V], a phase current of 20 [A], an apparent power of 12 [kVA], and a reactive power of 8.5 [kvar], the capacitance of the phase advancing capacitor C is calculated as C=423 [μF], and the inductance of the inductor L is calculated as L=1.4 [mH], at a power supply frequency of 50 [Hz].

The standby power cutting-off device 22 will be described below with reference to FIG. 1. The standby power cutting-off device 22 comprises three relay switches 23, each of which is connected between the three lines 26b and three lines 26c connected to the three-phase load 14, and a controller 25 such as a microcomputer or the like for turning on and off the relay switches 23.

As shown in FIG. 1, the standby power cutting-off device 22 includes a power supply for supplying electric power to the controller 25 and the coils (not shown) of the relay switches 23, based on two phases, e.g., phases S and T, of the three-phase system power supply 15.

The standby power cutting-off device 22, which is connected between the lines 26b and the lines 26c, serves to cut off standby electric power from the transformer 18, i.e., electric power supplied from the three-phase system power supply 15 and consumed by the primary side of the transformer 18, when the single-phase electric generators 16a, 16b, 16c do not generate electric energy. The standby power cutting-off device 22 also is effective to cut off standby power from the capacitive phase advancer 20.

The controller 25 detects the output voltage, current, and electric power, etc., of the solar cell 30c of the single-phase electric generator 16c. If the detected levels are equal to or smaller than given reference values, i.e., threshold values, then the controller 25 opens the relay switches 23 in order to cut off the electric power consumed by the primary side of the transformer 18. Since the solar cells 30a, 30b, 30c are used, the controller 25 may employ a timer having a calendar clock, or a so-called solar timer, with regional information registered therein, wherein the timer opens and closes the relay switches 23 at or about sunrise and sunset. Stated more simply, the timer may open the relay switches 23 at night and close the relay switches 23 during the daytime. The relay switches 23 are openable and closable simultaneously.

The power conversion system 10, which incorporates therein the single-phase to three-phase converter 12 according to the above embodiment of the present invention, has the following features and offers the following advantages:

1. The power conversion system 10 provides a connection between the single-phase electric generators 16a, 16b, 16c and the n-phase (n represents an integer of 3 or greater) electric power system via the transformer 18.

2. The transformer 18 may comprise a plurality of transformers with separate cores for respective phases (FIG. 3), or may comprise a single transformer with a common core shared by the phases (FIG. 4).

3. The primary windings of the transformers 18r, 18s, 18t that make up the three-phase three-wire 200 V system output 36 may be delta-connected or wye-connected.

4. The primary windings of the transformers 18r, 18s, 18t should preferably have voltage regulating taps 51, 52, 53 (FIG. 5).

5. The secondary windings of the transformers 18r, 18s, 18t, which are connected to the single-phase electric generators 16a, 16b, 16c, are independent of each other (FIG. 2, etc.).

6. If the single-phase electric generators 16a, 16b, 16c output single-phase three-wire electric power, the secondary windings (U-0-W) of the transformers 18r, 18s, 18t, which are connected to the single-phase electric generators 16a, 16b, 16c, have respective center taps O (0 [V], FIG. 2).

7. If the secondary windings of the transformers 18r, 18s, 18t, which are connected to the single-phase electric generators 16a, 16b, 16c, have respective center taps O, the center taps O may be grounded (FIG. 2).

8. If the center taps O are grounded, the center taps O may be connected together and grounded (FIG. 2), or the center taps O may be separately grounded.

9. The single-phase electric generators 16a to 16c are provided as a set of n single-phase electric generators (n=3 in the above embodiment). One or more sets of n single-phase electric generators may be added.

10. If a large-capacity power conversion system is to be constructed, then a set of single-phase electric generators and a transformer, which is commensurate in capacity to the set of single-phase electric generators, may be connected in a 1:1 correspondence, so as to form an auxiliary system, wherein such auxiliary systems are added to form a large-capacity power conversion system.

11. If a large-capacity power conversion system is to be constructed, alternatively, m sets of single-phase electric generators and a transformer, which is commensurate in capacity to the m sets of single-phase electric generators, may be connected in an m:1 correspondence, so as to form a large-capacity power conversion system.

12. When the single-phase to three-phase converter 12 is not in operation, the single-phase to three-phase converter 12 may be disconnected by opening the relay switches 23 of the standby power cutting-off device 22, in order to cut off the standby power of the transformer 18.

13. The relay switches 23 are opened by the controller 25 when the detected output voltage, current, and electric power, etc., of the solar cell 30c of the single-phase electric generator 16c are equal to or smaller than reference values. If the single-phase electric generators 16a, 16b, 16c comprise solar cells (FIG. 2), the controller 25 may have a timer including a calendar clock, with regional information registered therein, in which case the controller may open and close the relay switches 23 at or about sunrise and sunset.

14. If the relay switches 23 are opened and closed based on the monitored electric power, then the relay switches 23 may be opened when the total amount of electric power supplied to the secondary side of the transformer 18 becomes lower than the loss experienced by the transformer 18.

15. Electric power may be monitored by individually monitoring all of the power outputs of the single-phase electric generators 16a, 16b, 16c and totaling the monitored power outputs, or by monitoring the power outputs altogether at a point where they are input to the transformer 18. Alternatively, the power output of the single-phase electric generator 16a may be monitored, and the monitored power output may be multiplied by n (n=3 in the above embodiment).

16. If the relay switches 23 are closed by monitoring the voltage, then the relay switches 23 may be closed when the input voltages of the solar cells 30a, 30b, 30c (the single-phase electric generators 16a, 16b, 16c) are equal to or higher than a certain level.

17. If the voltage to current phase relationship between the single-phase electric generator side of the transformer 18 and the system side of the transformer 18 is poor, then the power factor can be improved by means of the capacitive phase advancer 20.

18. Since the single-phase electric generator side and the system side are isolated from each other by the transformer 18, no significant problem arises even if a ground fault occurs on the side of the single-phase electric generator, for example.

19. Even when one phase of the single-phase electric generators 16a, 16b, 16c fails, the single-phase to three-phase converter 12 continues to operate, although the current corresponding to the failing phase disappears. If such a lack of equilibrium is not desirable, then the absence of such a current may be detected in order to detect the lack of equilibrium, and the relay switches 23 may be opened.

As described above, the single-phase to three-phase converter 12 according to the above embodiment includes three single-phase electric generators 16a, 16b, 16c together with the transformer 18, which is made up of the three transformers 18r, 18s, 18t, the secondary windings of which are connected to outputs of the single-phase electric generators 16a, 16b, 16c, for thereby converting the single-phase three-wire 200 V system outputs 34a, 34b, 34c from the single-phase electric generators 16a, 16b, 16c into a three-phase three-wire 200 V system output 36. The single-phase to three-phase converter according to the present invention is thus capable of converting the electric power outputs from n (n represents an integer of 3 or greater) single-phase electric generators into an n-phase electric power system output.

Although certain preferred embodiments of the present invention have been shown and described in detail, it should be understood that various changes and modifications may be made to the embodiments without departing from the scope of the invention as set forth in the appended claims.

What is claimed is:

1. A single-phase to n-phase converter comprising:
n (n represents an integer of 3 or greater) single-phase electric generators; and
a single-phase to n-phase transformer for converting n single-phase electric power outputs from the n single-phase electric generators into an n-phase system output and supplying the n-phase system output to a primary side of the single-phase to n-phase transformer, the n single-phase electric generators being connected to a secondary side of the single-phase to n-phase transformer.

2. A single-phase to n-phase converter according to claim 1, wherein the single-phase to n-phase transformer comprises a single transformer having separate cores for each of respective n phases.

3. A single-phase to n-phase converter according to claim 1, wherein the single-phase to n-phase transformer comprises n transformers for each of respective n phases.

4. A single-phase to n-phase converter according to claim 1, further comprising:
a capacitive phase advancer connected to the primary side of the single-phase to n-phase transformer.

5. A single-phase to n-phase converter according to claim 1, further comprising:
a standby power cutting-off device connected to the primary side of the single-phase to n-phase transformer.

6. A single-phase to n-phase converter according to claim 4, further comprising:
a standby power cutting-off device connected to an output side of the capacitive phase advancer.

7. A single-phase to n-phase converter according to claim 1, wherein the single-phase to n-phase transformer has primary windings on the primary side thereof, the primary windings having respective voltage regulating taps.

8. A single-phase to n-phase converter according to claim 1, wherein the n comprises 3.

9. A single-phase to n-phase converter according to claim 1, wherein the single-phase electric generators comprise respective solar cells and respective inverters, which are supplied with DC outputs from the solar cells.

10. A single-phase to n-phase converter according to claim 5, wherein the standby power cutting-off device comprises switches connected to respective n-phase lines, and a controller for opening and closing the switches, wherein the controller opens the switches when the single-phase electric generators are not generating electric power.

11. A single-phase to n-phase converter according to claim 10, wherein the single-phase electric generators comprise respective solar cells and respective inverters, which are supplied with DC outputs from the solar cells, and the controller opens and closes the switches using a solar timer.

12. A power conversion system comprising:
a single-phase to n-phase converter including n (n represents an integer of 3 or greater) single-phase electric generators, and a single-phase to n-phase transformer for converting n single-phase electric power outputs from the n single-phase electric generators into an n-phase system output and supplying the n-phase system output to a primary side of the single-phase to n-phase transformer, the n single-phase electric generators being connected to a secondary side of the single-phase to n-phase transformer;
an n-phase system power supply; and
an n-phase load supplied with electric power from the single-phase to n-phase converter and the n-phase system power supply.

13. A power conversion system according to claim 12, wherein the n comprises 3.
